(19) United States
(12) Patent Application Publication
(10) Pub. No.: US 2016/0197571 A1
(43) Pub. Date: Jul. 7, 2016

(54) Wireless Power System for Electric Motors

(71) Applicant: The Boeing Company, Chicago, IL (US)

(72) Inventors: Kerri L. Olson, Mukilteo, WA (US); Brian Jay Tillotson, Kent, WA (US); Peng Zeng, Newcastle, WA (US)

(21) Appl. No.: 14/589,169

(22) Filed: Jan. 5, 2015

(51) Int. Cl. H02P 27/00; H04B 5/00; H02P 5/00

(52) U.S. Cl. CPC H02P 27/00; H02P 5/00; H04B 5/0037

(57) ABSTRACT

A method and apparatus for supplying power to a group of wireless motors. A request for the power is received for the group of wireless motors associated with a robot. An amount of power available is identified from a power source for wireless transmission to the group of wireless motors. Operation of the group of wireless motors is controlled based on the amount of power available.

### BACKGROUND INFORMATION

1. Field

The present disclosure relates generally to electric motors, and in particular, to wireless electric motors. Still more particularly, the present disclosure relates to a method and apparatus for controlling the transmission of power to wireless electric motors using a wireless transmitter.

2. Background

An electric motor is a device that converts electrical power into mechanical power. Electric motors may be used for various applications. For example, without limitation, electric motors may be used to drive fans, pumps, tools, disk drives, drills, and other types of devices. Electric motors may be used in various environments. For example, electric motors may be used for applications on various fixed and mobile platforms, such as aircraft and other vehicles.

Electric motors are used on aircraft to perform various functions on the aircraft. For example, without limitation, electric motors on an aircraft may be used to move flight control surfaces, raise and lower landing gear, and perform other functions on the aircraft.

As another example, electric motors are used in manufacturing products such as an aircraft. For example, electric motors may be used on robots such as crawlers, robotic arms, and other types of robots to perform operations to assemble the aircraft. These operations may include, for example, drilling holes, installing fasteners, and other operations used to assemble the aircraft.

In a manufacturing environment, sending power to electric motors may be more cumbersome than desired. Cables connecting electric motors to a power source may cause more issues than desired. For example, cables may become disconnected during movement of robots if the robots move farther than anticipated with respect to the length of the cables. Further, the movement or repositioning of robots may be more limited than desired when using cables.

Also, the movement of robots may result in the cables becoming twisted and including kinks that limit the movement of robots. Additionally, the cables may become frayed or develop other inconsistencies that require maintenance or replacement of the cables more frequently than desired.

In some manufacturing facilities, wireless electric motors may be used. Power is transmitted to the wireless electric motors using wireless signals. The transmission of power through wireless signals to wireless electric motors may be more challenging than anticipated or desired.

For example, environmental factors may reduce the amount of power that reaches a wireless electric motor. Changes in distance, objects that absorb or block wireless signals, and other factors may reduce the amount of power that reaches the wireless electric motor. Therefore, it would be desirable to have a method and apparatus that take into account at least some of the issues discussed above, as well as other possible issues. For example, it would be desirable to have a method and apparatus that overcome issues in providing a desired amount of power to a wireless electric motor.

### SUMMARY

In one illustrative embodiment, a robot power system comprises a controller that receives a request for power for a group of wireless motors associated with a robot. The controller also identifies an amount of power available from a power source for wireless transmission to the group of wireless motors. Further, the controller controls operation of the robot based on the amount of power available.

In another illustrative embodiment, an apparatus comprises a transmitter system and a controller. The transmitter system sends power in wireless signals to a group of wireless motors during operation of the transmitter system. The controller receives a request for the power for the group of wireless motors. The controller also identifies an amount of power available from a power source for wireless transmission to the group of wireless motors. Further, the controller controls the operation of the transmitter system to send the power in the wireless signals to the group of wireless motors based on the amount of power available from the power source.

In yet another illustrative embodiment, a method for supplying power to a group of wireless motors is presented. A request for the power is received for the group of wireless motors associated with a robot. An amount of power available is identified from a power source for wireless transmission to the group of wireless motors. Operation of the group of wireless motors is controlled based on the amount of power available.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a wireless motor system in the form of a block diagram in accordance with an illustrative embodiment;

FIG. 2 is an illustration of a platform in the form of a block diagram in which a group of wireless motors may be located in accordance with an illustrative embodiment;

FIG. 3 is an illustration of a wireless motor system in the form of a block diagram in accordance with an illustrative embodiment;

FIG. 4 is an illustration of a message flow diagram of communications between controllers from a wireless power transmission in accordance with an illustrative embodiment;

FIG. 5 is another illustration of a message flow diagram of communications between controllers from wireless power transmission in accordance with an illustrative embodiment;

FIG. 6 is another illustration of a message flow diagram of communications between controllers from wireless power transmission in accordance with an illustrative embodiment;

FIG. 7 is an illustration of a flowchart of a process for supplying power to a group of wireless motors in accordance with an illustrative embodiment;

FIG. 8 is an illustration of a flowchart of a process for controlling operation of a group of wireless motors based on the amount of power available in accordance with an illustrative embodiment;

FIG. 9 is an illustration of a flowchart of a process for controlling operation of a group of wireless motors based on the amount of power available in accordance with an illustrative embodiment;

FIG. 10 is an illustration of a flowchart of a process for controlling operation of a group of wireless motors based on the amount of power available in accordance with an illustrative embodiment;

FIG. 11 is an illustration of a flowchart of a process for managing unrequested power received over wireless signals in accordance with an illustrative embodiment;

FIG. 12 is an illustration of a flowchart of a process for managing tasks performed by a group of wireless motors based on the amount of power available in accordance with an illustrative embodiment; and

FIG. 13 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account that sending power to wireless electric motors over wireless signals is more challenging than desired. The illustrative embodiments recognize and take into account that one potential solution may involve having a human operator check the transmitter to identify the amount of power being transmitted and check the electric motor to identify how much power is being received. The human operator may then make adjustments to the amount of power being transmitted, positioning of transmitters, tasks performed by a robot in which the electric motor is located, or some combination thereof. This process may be useful in setting up robots on the manufacturing floor. Adjustments to the tasks may be made to tasks performed by the robots. These adjustments to the tasks may change the amount of power used by electric motors. The illustrative embodiments recognize and take into account that this type of process may be more time-consuming and tedious than desired in a manufacturing environment.

Further, the illustrative embodiments recognize and take into account that changes in the positioning of those robots or other equipment may result in changes in the amount of power that actually reaches the robots containing wireless electric motors. As a result, changes in the configuration of the manufacturing floor may result in robots receiving insufficient power for the wireless electric motors. The illustrative embodiments recognize and take into account that the situation results in having to measure power being transmitted and received, taking more time and effort than desired.

The illustrative embodiments also recognize and take into account that the power source may transmit power in wireless signals at a level that is sufficient for all of the wireless electric motors operating in a manufacturing environment. For example, the power source may transmit an amount of power that is sufficient for all of the wireless electric motors with an increased amount to take into account environmental factors that may occur. This solution is inefficient with respect to the amount of power that may be wasted. Having all of the wireless electric motors operating at the same time and requiring maximum power may occur infrequently. Additionally, the cost for this type of solution may be greater than desired. The source for the power may need to be supplemented or replaced to provide a sufficient amount of power.

Thus, the illustrative embodiments provide a method and apparatus for supplying power to wireless motors. For example, a controller may receive a request for power for a group of wireless motors and identify an amount of power available from a power source for wireless transmission to the group of wireless motors. The controller may also control operation of a transmitter to send the power in wireless signals to the group of wireless motors based on the amount of power available from the power source.

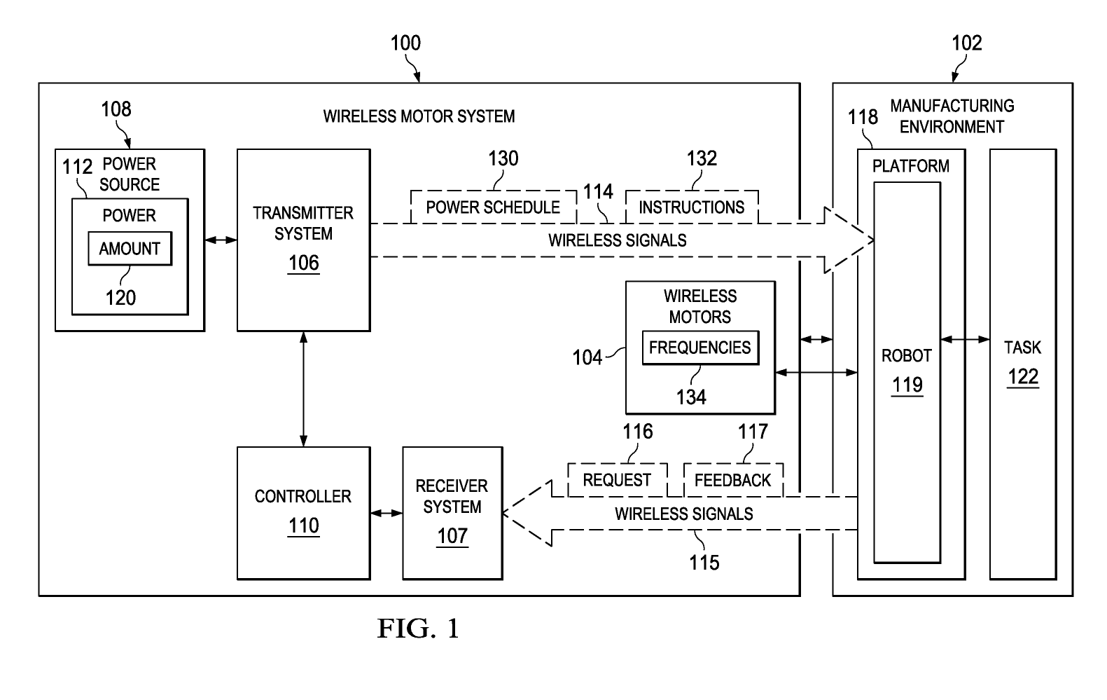

With reference now to the figures, and in particular, with reference to FIG. 1, an illustration of a wireless motor system is depicted in accordance with an illustrative embodiment. Wireless motor system 100 is an example of an electric motor system in which an illustrative embodiment may be implemented. In this illustrative example, wireless motor system 100 is located in manufacturing environment 102 but may be implemented in other environments. For example, wireless motor system 100 may be implemented in a maintenance environment, an aircraft, a power plant, or in some other suitable environment.

In this illustrative example, wireless motor system 100 includes a number of different components. As depicted, wireless motor system 100 includes a group of wireless motors 104, transmitter system 106, receiver system 107, power source 108, and controller 110. As used herein, “a group of,” when used with reference to items, means one or more items. For example, a group of wireless motors is one or more wireless motors.

The group of wireless motors 104 is one or more physical electric motors. The group of wireless motors 104 receives power 112 from power source 108. Power 112 is received from power source 108 without a physical connection of a cable between wireless motors 104 and power source 108.

Transmitter system 106 is a hardware system and includes one or more transmitters. As depicted, transmitter system 106 sends power 112 in wireless signals 114 to the group of wireless motors 104 during operation of transmitter system 106. In one illustrative example, wireless signals 114 are magnetic fields that have a frequency that oscillates in this illustrative example. The magnetic fields provide power to the group of wireless motors 104.

The group of wireless motors 104 may receive power through wireless signals 114, either directly, indirectly, or both directly and indirectly. For example, power 112 that is transmitted in wireless signals 114 may be directly received as magnetic fields in coils in the group of wireless motors 104. For example, a wireless motor in the group of wireless motors 104 may have a rotor that is rotatable and comprised of a magnetic material. Coils in a stator in the wireless motor may generate a magnetic field in response to wireless signals 114. In this manner, the coils may cause the rotor to rotate. In another illustrative example, the wireless motor may be an actuator. As an actuator, the wireless motor may make linear or rotary movement depending on the rotation.

In still another illustrative example, the group of wireless motors 104 may receive power 112 indirectly through wireless signals 114 from a receiver that generates power 112 from wireless signals 114. For example, wireless signals 114 may be radio frequency (RF) signals. The radio frequency signals may be converted into power 112 usable by the group of wireless motors 104. For example, the radio frequency signals may be converted into an electrical current used by the group of wireless motors 104.

Receiver system 107 is a hardware system. Receiver system 107 includes one or more receivers. Receiver system 107 receives wireless signals 115. Wireless signals 115 may include request 116, feedback 117, or other suitable information. Request 116 is a request for power 112. Feedback 117 includes information about whether power 112 received by the group of wireless motors 104 is sufficient in this illustrative example.

Power source 108 is a hardware system and supplies power 112 sent by transmitter system 106 to the group of wireless motors 104 over wireless signals 114. Power source 108 may be selected from at least one of a battery, an alternating current source, an auxiliary power unit, a power converter, or some other suitable power source that generates power 112.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, the group of wireless motors 104 may be associated with platform 118. In this illustrative example, platform 118 may be robot 119. When one component is “associated” with another component, the association is a physical association in the depicted examples. For example, a first component, the group of wireless motors 104, may be considered to be physically associated with a second component, robot 119, by at least one of being secured to the second component, bonded to the second component, mounted to the second component, welded to the second component, fastened to the second component, or connected to the second component in some other suitable manner. The first component also may be connected to the second component using a third component. The first component may also be considered to be physically associated with the second component by being formed as part of the second component, extension of the second component, or both.

Controller 110 manages supplying power 112 to the group of wireless motors 104. Additionally, controller 110 also may control the operation of the group of wireless motors 104. In particular, controller 110 may control the operation of the group of wireless motors 104 based on amount 120 of power 112 available from power source 108.

In the illustrative example, controller 110 may be implemented in software, hardware, firmware or a combination thereof. When software is used, the operations performed by controller 110 may be implemented in program code configured to run on hardware, such as a processor unit. When firmware is used, the operations performed by controller 110 may be implemented in program code and data and stored in persistent memory to run on a processor unit. When hardware is employed, the hardware may include circuits that operate to perform the operations in controller 110.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

During operation of wireless motor system 100, controller 110 receives request 116 for power 112 for the group of wireless motors 104. As depicted, request 116 is received over wireless signals 115 at receiver system 107.

Controller 110 identifies amount 120 of power 112 available from power source 108 for wireless transmission to the group of wireless motors 104. Amount 120 of power 112 available from power source 108 may vary over time. For example, amount 120 may be less when power 112 is transmitted to other robots or devices. The transmission to other robots for devices may be wired or wireless, depending on the particular implementation.

In this illustrative example, controller 110 controls transmitter system 106. In particular, controller 110 controls the operation of transmitter system 106 to send power 112 in wireless signals 114 to the group of wireless motors 104 based on amount 120 of power 112 available from power source 108.

In this illustrative example, the group of wireless motors 104 is associated with platform 118. For example, platform 118 takes the form of robot 119. Wireless motors 104 may operate in robot 119 to perform task 122. Task 122 may be selected from one of drilling a hole, installing fasteners, performing an inspection, applying paint, applying sealant, moving robot 119, moving an item, moving an arm for robot 119 or some other suitable task.

As depicted, controller 110 receives request 116 for power 112 from robot 119 for the group of wireless motors 104 associated with robot 119. In this illustrative example, request 116 may be received in wireless signals 115 from robot 119.

In this illustrative example, request 116 for power 112 may take a number of different forms. For example, request 116 for power 112 may be selected from at least one of an identification of a task to be performed by the group of wireless motors 104 or a desired amount of power for a selected period of time.

Controller 110 identifies amount 120 of power 112 available from power source 108 for wireless transmission to the group of wireless motors 104. Controller 110 controls the operation of robot 119 based on amount 120 of power available from power source 108.

In controlling the operation of robot 119, controller 110 controls the operation of transmitter system 106. In particular, controller 110 controls the sending of power 112 in wireless signals 114 to the group of wireless motors 104 by transmitter system 106 based on amount 120 of power 112 available from power source 108.

Additionally, controller 110 may receive feedback 117 from robot 119 over wireless signals 114. Feedback 117 indicates whether power 112 being sent to the group of wireless motors 104 is sufficient. In response to feedback 117, indicating that power 112 is insufficient, controller 110 may increase power 112 sent to the group of wireless motors 104 when amount 120 of power 112 available from power source 108 is sufficient to increase power 112 being sent to the group of wireless motors 104.

In the illustrative example, controller 110 also may control the operation of robot 119 by sending power schedule 130 to robot 119. As depicted, power schedule 130 may be sent in wireless signals 114. Power schedule 130 indicates what power 112 is available. Power schedule 130 also may indicate at what times the amount of power 112 is available for use.

Power schedule 130 may indicate that different amounts of power 112 are available at different times or for different periods of time. The period of time is how long the amount of power is needed. The period of time also may indicate a start time for when the powers are needed in some illustrative examples.

With power schedule 130, robot 119 may determine how to perform task 122 using the group of wireless motors 104. For example, robot 119 may delay the performance of task 122 by a period of time until amount 120 of power 112 needed by the group of wireless motors 104 to perform task 122 is available for transmission to robot 119 from power source 108. In another example, the amount of time needed for task 122 may be increased to take into account a slower operation of the group of wireless motors 104 based on amount 120 of power 112 available over time as indicated in power schedule 130.

In yet another illustrative example, controller 110 may control the operation of robot 119 by changing task 122 performed by robot 119. For example, controller 110 may send instructions 132 to robot 119 to change task 122. Instructions 132 may be sent in wireless signals 114. This change in task 122 is based on amount 120 of power 112 available from power source 108.

The change in task 122 may be, for example, a change in when task 122 starts, the duration of task 122, the operations performed in task 122, or other suitable changes to task 122. In some illustrative examples, the change may be to cancel task 122 for robot 119.

In one illustrative example, controller 110 may control which ones of wireless motors 104 receive power 112 when more than one wireless motor is present in the group of wireless motors 104. For example, the group of wireless motors 104 may have a group of frequencies 134. Each wireless motor may have the same or different frequency from another wireless motor depending on the implementation. For example, this frequency is the frequency at which the coils in a wireless motor magnetize and cause a rotor to rotate. In this manner, controller 110 may select the group of frequencies 134 that cause desired ones of the group of wireless motors 104 to receive power 112 to operate in performing task 122. In this manner, wireless motor system 100 may be a robot power system when the group of wireless motors 104 is used in robot 119.

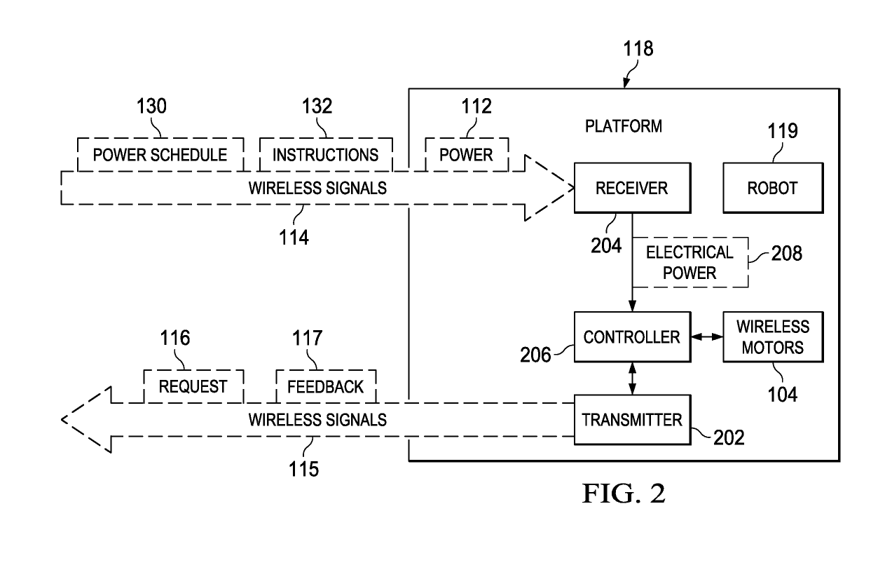

Turning next to FIG. 2, an illustration of a platform in which a group of wireless motors may be located is depicted in accordance with an illustrative embodiment. In this illustrative example, the group of wireless motors 104 is associated with platform 118. In the illustrative examples, the same reference numeral may be used in more than one figure. This reuse of a reference numeral in different figures represents the same element in the different figures.

In this illustrative example, platform 118 takes the form of robot 119. As depicted, platform 118 includes transmitter 202, receiver 204, controller 206, and the group of wireless motors 104. In this illustrative example, transmitter 202 and receiver 204 are separate components from transmitter system 106 and receiver system 107 in FIG. 1.

As depicted, transmitter 202 is a hardware device that transmits wireless signals 115. Transmitter 202 may transmit information, such as, for example, request 116 for power 112, feedback 117, and other suitable information. Other information may be transmitted to other devices or components in addition to or in place of those in wireless motor system 100 in FIG. 1. For example, data, sensor information, and other suitable information may be sent.

In this illustrative example, receiver 204 is a hardware device that receives wireless signals 114 transmitted by transmitter system 106 in FIG. 1. Receiver 204 is a hardware device that converts wireless signals 114 into power 112 for use by the group of wireless motors 104. In particular, receiver 204 converts wireless signals 114 into electrical power 208 used by the group of wireless motors 104.

Additionally, receiver 204 also may receive information, such as power schedule 130, instructions 132, or other suitable information from controller 206.

As depicted, controller 206 is a hardware device and may take a form similar to that of controller 110 in FIG. 1. As depicted, controller 206 may control distribution of electrical power 208 to the group of wireless motors 104.

When used in robot 119, controller 206 may have various levels of intelligence. For example, controller 206 may receive instructions specifying specific movements for robot 119, how much electrical power 208 to send to wireless motors 104, or other operations. With this level of intelligence, controller 206 may receive an encoder position, a distance, revolutions per minute for the group of wireless motors 104, or other instructions on operations to perform for task 122 in FIG. 1. Controller 206 may be an application-specific integrated circuit (ASIC), a programmable logic array (PLA), or other suitable hardware.

In another illustrative example, controller 206 may have a higher level of intelligence. For example, controller 206 may include one or more processor units similar to those found in computer systems. A processor unit used in controller 206 may run instructions for software that may be loaded into memory in controller 206. With this type of implementation, the processor unit may be a group of processors, a multi-processor core, or some other type of processor, depending on the particular implementation. The software may be run to perform task 122 in FIG. 1.

In still another illustrative example, controller 206 may implement artificial intelligence architecture. For example, controller 206 may include at least one of a neural network, natural language processing, a Bayesian network, swarm intelligence, DNA computing, or other suitable architectures or techniques.

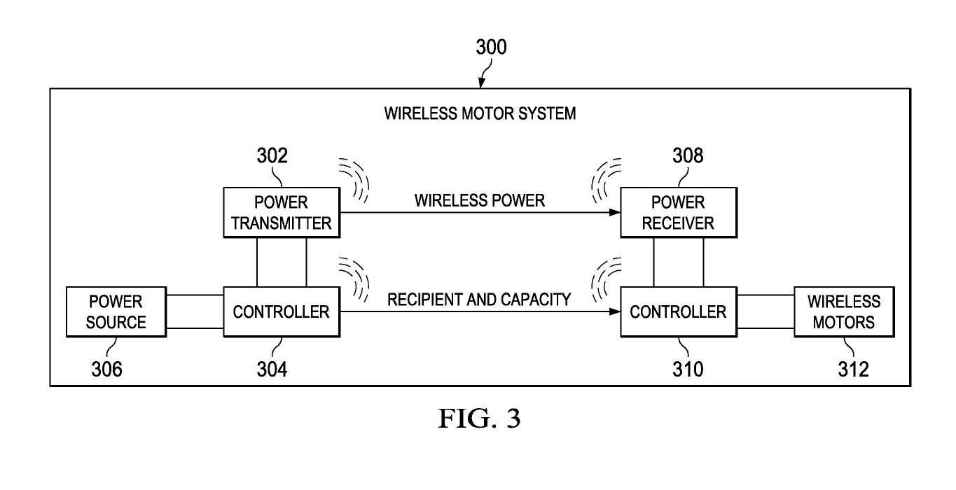

With reference now to FIG. 3, an illustration of a wireless motor system is depicted in accordance with an illustrative embodiment. Wireless motor system 300 is an example of one implementation for wireless motor system 100 in FIG. 1.

As depicted, wireless motor system 300 includes a number of different components. In this illustrative example, wireless motor system 300 includes power transmitter 302, controller 304, power source 306, power receiver 308, controller 310, and a group of wireless motors 312. In this illustrative example, power is supplied using power source 306, power transmitter 302, and controller 304.

As depicted, controller 304 may receive a request for power from controller 310. The request is sent over wireless signals using transmitters located in controller 304 and controller 310. Controller 304 and controller 310 may each include a receiver and a transmitter for exchanging information over wireless signals.

In response to receiving a request for power, controller 304 may send power from power source 306 to the group of wireless motors 312 using power transmitter 302. Power transmitter 302 sends power in wireless signals that are received by power receiver 308. The amount of power sent in the wireless signals is based on the amount of power available from power source 306.

Power receiver 308 receives wireless signals. In turn, power receiver 308 generates electrical power from the wireless signals received from power transmitter 302.

Controller 304 sends a confirmation that the requested power is being sent. If the amount of power requested is not available, controller 304 may send information regarding what power is available for use by the group of wireless motors 312. This availability may be sent by controller 304 to controller 310 in the power schedule. The power schedule indicates what amount of power is available and when the power is available. This power schedule may be used by controller 310 to adjust the operation of the group of wireless motors 312 based on what power is available from power source 306 for use by the group of wireless motors 312.

As depicted, controller 310 sends the electrical power from power receiver 308 to the group of wireless motors 312. Controller 310 may regulate the distribution of the electrical power generated by power receiver 308. In particular, controller 310 may send different amounts of power for different periods of time to different wireless motors in the group of wireless motors 312.

In another illustrative example, controller 304 may send instructions on how the power should be distributed to different wireless motors in the group of wireless motors 312. For example, the group of wireless motors 312 may include three wireless motors. In this illustrative example, controller 310 may send ⅓ of the electrical power to the first motor in the group of wireless motors 312; ½ of the electric power to a second motor in the group of wireless motors 312, and ⅙ of the electrical power to a third motor in the group of wireless motors 312.

Additionally, controller 310 may send power to other devices other than the group of wireless motors 312. For example, if the group of wireless motors 312 is located in a robot, the electrical power may be sent to other devices such as sensors in the robot.

The illustration of wireless motor system 100 and the different components and implementations in FIGS. 1-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, the group of wireless motors 104 may be used in other platforms other than robot 119. For example, the group of wireless motors 104 may be used in different types of platforms selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a maintenance facility, a building, or for some other suitable type of platform in which wireless motors may be used.

As another example, wireless motor system 100 may be used with one or more robots in addition to robot 119 in FIG. 1. As another example, transmitter system 106 may be distributed such that transmitters are located in different locations within manufacturing environment 102. The distribution of transmitters may be selected to provide power 112 to any wireless electric motors that may be present in manufacturing environment 102. The selection of locations for transmitters in transmitter system 106 may be to avoid blind spots. In other illustrative examples, an intentional blind spot may be selected to avoid a magnetically opaque object.

As another example, information, such as power schedule 130, instructions 132, and other information may be sent using other types of wireless signals other than wireless signals 114. For example, if wireless signals 114 are radio frequency signals, the wireless signals used to send information may be, for example, optical signals, infrared signals, or other suitable types of signals. Also, controller 110 may be at a location selected from at least one of power source 108, robot 119, or a remote location.

In yet another illustrative example, the functional blocks showing that a transmitters system, a receiver system, a transmitter, a receiver, or some combination thereof may be combined into a single functional block. The single functional block may take the form of a transceiver or transceiver system that performs both transmitting and receiving wireless signals. In particular, receivers, transmitters, transceivers, and other types of hardware may be used to implement the functional blocks shown in FIGS. 1-3.

As another example, when controller 110 is located at platform 118, controller 206 in FIG. 2 may be omitted. As another example, one or more power sources in addition to or in place of power source 108 also may be present for providing power 112.

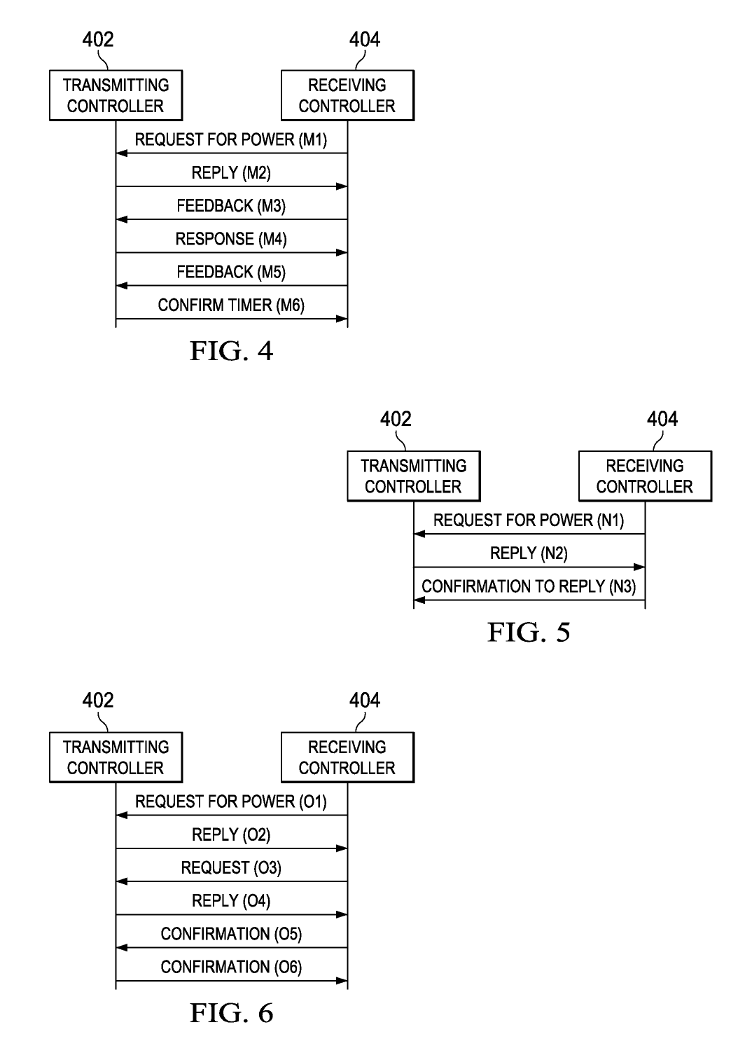

With reference now to FIG. 4, an illustration of a message flow diagram of communications between controllers from a wireless power transmission is depicted in accordance with an illustrative embodiment. In this illustrative example, transmitting controller 402 and receiving controller 404 communicate with each other to coordinate the transmission of wireless power. Transmitting controller 402 controls the transmission of power by a transmitter system, such as transmitter system 106 in FIG. 1 and is an example of controller 110 in FIG. 1. Receiving controller 404 requests power that is received by a group of wireless motors, such as the group of wireless motors 104 in FIG. 1. Receiving controller 404 is an example of controller 206 in FIG. 2.

In this message flow, receiving controller 404 sends a request for power to transmitting controller 402 (message M1). In message M1, the request for power may indicate the amount of power needed and how long the power is needed. For example, the request may be for 50 watts of power for 10 minutes.

Transmitting controller 402 sends a reply to receiving controller 404 (message M2). Message M2 is a reply made in response to the request and is sent when a sufficient amount of power is available from the power source to fulfill the request for power sent in message M1. For example, the reply may be transmitting 50 watts of power.

In the instance in which environmental factors or other factors result in less than 50 watts of power being received, receiving controller 404 sends feedback to transmitting controller 402 indicating that insufficient power is being received (message M3). The feedback may be, for example, only 40 watts of power is being received and that amount power is insufficient.

Transmitting controller 402 may send more power based on the amount of power available from the power source, or perform an analysis in the illustrative example. For example, transmitting controller 402 may determine whether the reduced amount of power being received as compared to the amount of power being transmitted is a result of distance, objects, or other factors.

In an illustrative example, transmitting controller 402 determines whether additional power can be sent from the power source. Transmitting controller 402 sends a response to receiving controller 404 (message M4). In this example, the response may be additional power is being sent. Receiving controller 404 sends feedback to transmitting controller 402 confirming that the amount of power being received is sufficient (message M5). Feedback may be, for example, receiving 50 watts of power and the 10 minutes needed for the request and the period of the time for the amount of power should be based on starting at the timestamp in the message. In response, transmitting controller 402 sends a confirmation to receiving controller 404 that a timer for transmitting the power has been started (message M6).

With reference now to FIG. 5, another illustration of a message flow diagram of communications between controllers from wireless power transmission is depicted in accordance with an illustrative embodiment. In this illustrative example, a message flow between transmitting controller 402 and receiving controller 404 is depicted. In this example, the power available at the power source is insufficient for the group of wireless motors.

In this illustrative example, receiving controller 404 sends a request for power to transmitting controller 402 (message N1). For example, the request may be for 50 watts of power for 10 minutes.

Transmitting controller 402 identifies the amount power available is not sufficient to fulfill the request. As a result, transmitting controller 402 sends a reply to receiving controller 404 indicating the amount of power that can be supplied (message N2). For example, the reply may state that 40 watts of power is available for the requested period of time. In this example, 40 watts of power is being sent at the time message N2 is sent to receiving controller 404.

In response, receiving controller 404 sends a confirmation to the reply to transmitting controller 402 (message N3). The confirmation indicates that 40 watts of power are being received and that the period of time starts at the timestamp in the message.

With reference now to FIG. 6, another illustration of a message flow diagram of communications between controllers from wireless power transmission is depicted in accordance with an illustrative embodiment. In this illustrative example, a message flow between transmitting controller 402 and receiving controller 404 is depicted. In this example, the power available at the power source is insufficient for the group of wireless motors.

In this example, a request for power is received by transmitting controller 402 from receiving controller 404 (message O1). In this example, the request for power is for 50 watts of power for 10 minutes.

Transmitting controller 402 determines that only 40 watts of power can be transmitted instead of the requested 50 watts of power. Transmitting controller 402 sends a reply to receiving controller 404 (message O2). The reply indicates that only 40 watts of power can be supplied.

As depicted, receiving controller 404 sends a request for power to transmitting controller 402 (message O3). In this illustrative example, a new request for power is in the request. As depicted, the request for power is for 40 watts of power for five minutes and then for 50 watts of power for 10 minutes.

In response to the new request for power, transmitting controller 402 sends a reply to receiving controller 404 (message O4). In this example, the confirmation states that the new request can be met. The reply indicates that 40 watts of power will be sent for a period of time of 5 minutes, and 50 watts of power will be sent after five minutes for a period of time of 10 minutes. Receiving controller 404 sends a confirmation to transmitting controller 402 (message O5). The confirmation indicates that the 40 watts of power are being received and starting the timer should be based on the timestamp of the message. In response to receiving the confirmation from receiving controller 404, transmitting controller 402 sends a confirmation that the timer has been started (message O6).

The illustration of message flow between controllers in FIGS. 4-6 are not meant to limit the manner in which communications may occur within a wireless transmission system. For example, transmitting controller 402 may also communicate with other receiving controllers in addition to or in place of receiving controller 404. When additional receiving controllers are present, transmitting controller 402 may coordinate the transmission of power to the wireless motors associated with the different receiving controllers. When more than one receiving controller is present, transmitting controller 402 may communicate with the receiving controllers using different frequencies. Each receiving controller may be assigned a different frequency from other receiving controllers to avoid overlap of communication frequencies. Other communications techniques may be used in addition to or in place of different frequencies. For example, code division multiple access (CDMA) may be used to separate communications. With code division multiple access, each receiving controller may decide particular code. As yet another example, time division multiple access (TDMA) may be used with multiple receiving controllers in which different controllers are assigned different time slots for communications. Also, the communications may be encrypted in the different illustrative examples.

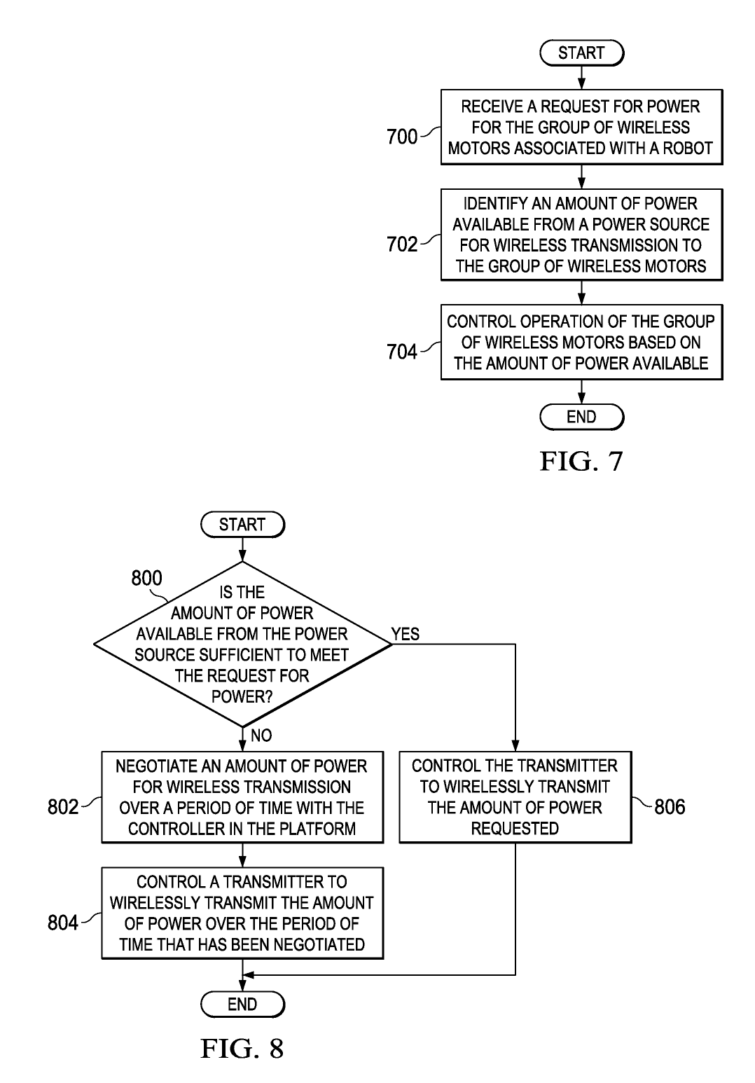

With reference now to FIG. 7, an illustration of a flowchart of a process for supplying power to a group of wireless motors is depicted in accordance with an illustrative embodiment. The process illustrated in FIG. 7 may be implemented in wireless motor system 100 in FIG. 1. One or more of the different operations may be performed by controller 110 in FIG. 1.

The process begins by receiving a request for power for a group of wireless motors associated with a robot (operation 700). In this illustrative example, a request for power may be used to perform one or more tasks by the group of wireless motors.

The process identifies an amount of power available from a power source for wireless transmission to the group of wireless motors (operation 702). Operation 702 may be performed in a number of different ways. For example, the total amount of power that can be generated by the power source may be compared to the power currently being drawn from the power source. That difference is the amount of power that is available for wireless transmission to the group of wireless motors. The process controls the operation of the group of wireless motors based on the amount of power available (operation 704) with the process terminating thereafter. Operation 704 may be performed by sending the request for power over wireless signals.

In other illustrative examples, operation 704 may include additional steps such as negotiating for the amount of power needed, the time period over which the amount of power is to be transmitted, or some combination thereof. In some illustrative examples, a schedule indicating amounts of power and transmission times for those amounts power may be sent to a controller in a robot or other platform. In this manner, the controller in the platform may adjust or change the manner in which the tasks are performed.

With reference to FIG. 8, an illustration of a flowchart of a process for controlling operation of a group of wireless motors based on the amount of power available is depicted in accordance with an illustrative embodiment. The process illustrated in FIG. 8 is an example of an implementation for operation 704 in FIG. 7.

The process begins by determining whether the amount of power available from the power source is sufficient to meet the request for power (operation 800). If the amount of power is not sufficient to meet the request, the process negotiates an amount of power for wireless transmission over a period of time with the controller in the platform (operation 802). In operation 802, the controller may be, for example, controller 206 in FIG. 2 or receiving controller 404 in FIG. 4. The process then controls a transmitter to wirelessly transmit the amount of power over the period of time that has been negotiated (operation 804) with the process terminating thereafter.

With reference again to operation 800, if the amount of power is sufficient to meet the request, the process controls the transmitter to wirelessly transmit the amount of power requested (operation 806). The process terminates thereafter.

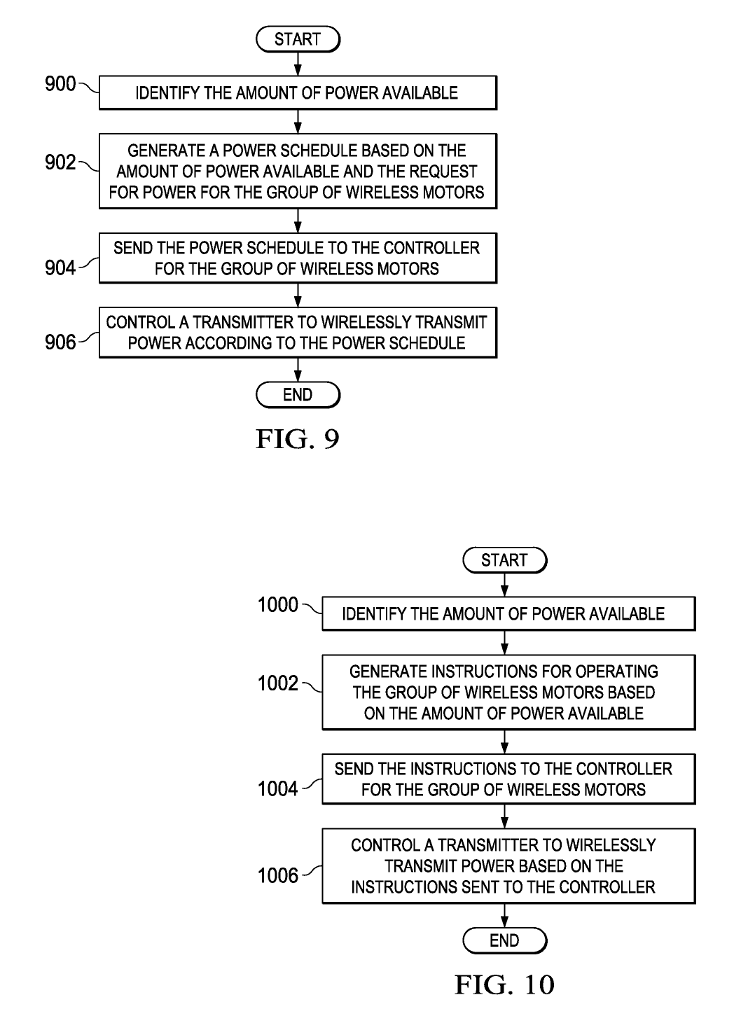

With reference to FIG. 9, an illustration of a flowchart of a process for controlling operation of a group of wireless motors based on the amount of power available is depicted in accordance with an illustrative embodiment. The process illustrated in FIG. 9 is an example of an implementation for operation 704 in FIG. 7.

The process begins by identifying the amount of power available (operation 900). The process then generates a power schedule based on the amount of power available and the request for power for the group of wireless motors (operation 902). The power schedule may be a level of power for a period of time that will be transmitted to the group of wireless motors. In other illustrative examples, the power schedule may include different levels of power over different periods of time.

The process sends the power schedule to the controller for the group of wireless motors (operation 904). The process then controls a transmitter to wirelessly transmit power according to the power schedule (operation 906) with the process terminating thereafter.

With reference to FIG. 10, an illustration of a flowchart of a process for controlling operation of a group of wireless motors based on the amount of power available is depicted in accordance with an illustrative embodiment. The process illustrated in FIG. 10 is an example of an implementation for operation 704 in FIG. 7.

The process begins by identifying the amount of power available (operation 1000). The process then generates instructions for operating the group of wireless motors based on the amount of power available (operation 1002). These instructions may take various forms. In this illustrative example, instructions change a task performed using the group of wireless motors. The change in task may include at least one of selecting a new task, changing a duration for the task, changing a start time for the task, or some other suitable alteration of the task.

The process then sends the instructions to the controller for the group of wireless motors (operation 1004). The process then controls a transmitter to wirelessly transmit power based on the instructions sent to the controller (operation 1006) with the process terminating thereafter. In one illustrative example, operation 1006 may include controlling the transmitter to not wirelessly transmit power to the group of wireless motors if the task is canceled.

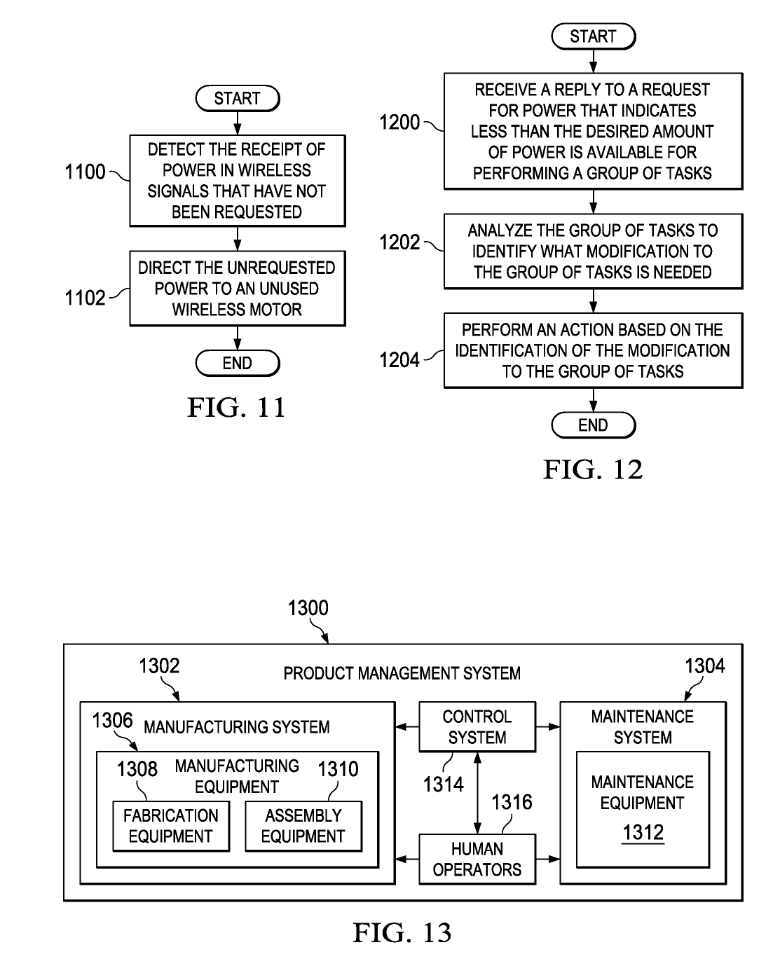

Turning next to FIG. 11, an illustration of a flowchart of a process for managing unrequested power received over wireless signals is depicted in accordance with an illustrative embodiment. The process illustrated in FIG. 11 may be implemented by at least one of controller 110 in FIG. 1 or controller 206 in FIG. 2. In particular, controller 110 may send instructions to controller 206. In other illustrative examples, controller 206 performs the operations without needing instructions from controller 110.

The process begins by detecting the receipt of power in wireless signals that have not been requested (operation 1100). The power received in operation 1100 may be more power than requested. In another example, power may not have been requested, but received.

The process directs the unrequested power to an unused wireless motor (operation 1102) with the process terminating thereafter. This process may be repeated as long as the unrequested power is received.

In this manner, excess power may be dissipated. In other illustrative examples, the receiver may be disconnected, wireless motors may be powered off, a battery may be charged, or other suitable actions may be taken.

With reference now to FIG. 12, an illustration of a flowchart of a process for managing tasks performed by a group of wireless motors based on the amount of power available is depicted in accordance with an illustrative embodiment. The process illustrated in FIG. 12 may be implemented in controller 206 in platform 118 in FIG. 2. The operations in this flowchart may be some operations performed as part of operation 704 in FIG. 7.

The process begins by receiving a reply to a request for power that indicates less than the desired amount of power is available for performing a group of tasks (operation 1200). The process analyzes the group of tasks to identify what modification to the group of tasks is needed (operation 1202). When a single task is present in the group tasks, the modification may be to change the task to be performed at a later time, use less power, or in some other suitable manner. When more than one task is present, the modification may include identifying which tasks may be performed with the amount of power available in the reply.

The process then performs an action based on the identification of the modification to the group of tasks (operation 1204) with the process terminating thereafter. The action may be to initiate the change to the group of tasks. In other illustrative examples, the action may include sending an alert to a human operator in addition to or in place of initiating the action. When the alert is sent to the human operator, the human operator may select what tasks are to be performed. As another alternative, the human operator also may adjust the power available.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Turning now to FIG. 13, an illustration of a block diagram of a product management system is depicted in accordance with an illustrative embodiment. Product management system 1300 is a physical hardware system. In this illustrative example, product management system 1300 may include at least one of manufacturing system 1302 or maintenance system 1304.

Manufacturing system 1302 is configured to manufacture products, such as an aircraft. As depicted, manufacturing system 1302 includes manufacturing equipment 1306. Manufacturing equipment 1306 includes at least one of fabrication equipment 1308 or assembly equipment 1310. In the illustrative example, wireless motor system 100 in FIG. 1 may be implemented in manufacturing equipment 1306. For example, wireless motor system 100 may be used with robots or other equipment that may employ motors to perform tasks.

Fabrication equipment 1308 is equipment that may be used to fabricate components for parts used to form an aircraft. For example, fabrication equipment 1308 may include machines and tools. These machines and tools may be at least one of a drill, a hydraulic press, a furnace, a mold, a composite tape laying machine, a vacuum system, a lathe, or other suitable types of equipment. Fabrication equipment 1308 may be used to fabricate at least one of metal parts, composite parts, semiconductors, circuits, fasteners, ribs, skin panels, spars, antennas, or other suitable types of parts.

Assembly equipment 1310 is equipment used to assemble parts to form an aircraft. In particular, assembly equipment 1310 may be used to assemble components and parts to form an aircraft. Assembly equipment 1310 also may include machines and tools. These machines and tools may be at least one of a robotic arm, a crawler, a faster installation system, a rail-based drilling system, or a robot. Assembly equipment 1310 may be used to assemble parts such as seats, horizontal stabilizers, wings, engines, engine housings, landing gear systems, and other parts for an aircraft.

In this illustrative example, maintenance system 1304 includes maintenance equipment 1312. Maintenance equipment 1312 may include any equipment needed to perform maintenance on an aircraft. In the illustrative example, wireless motor system 100 in FIG. 1 also may be implemented in maintenance equipment 1312. For example, wireless motor system 100 may be used with robots or other equipment that may employ motors to perform tasks.

Maintenance equipment 1312 may include tools for performing different operations on parts on an aircraft. These operations may include at least one of disassembling parts, refurbishing parts, inspecting parts, reworking parts, manufacturing placement parts, or other operations for performing maintenance on an aircraft. These operations may be for routine maintenance, inspections, upgrades, refurbishment, or other types of maintenance operations.

In the illustrative example, maintenance equipment 1312 may include ultrasonic inspection devices, x-ray imaging systems, vision systems, drills, crawlers, and other suitable devices. In some cases, maintenance equipment 1312 may include fabrication equipment 1308, assembly equipment 1310, or both to produce and assemble parts that may be needed for maintenance.

Product management system 1300 also includes control system 1314. Control system 1314 is a hardware system and may also include software or other types of components. Control system 1314 is configured to control the operation of at least one of manufacturing system 1302 or maintenance system 1304. In particular, control system 1314 may control the operation of at least one of fabrication equipment 1308, assembly equipment 1310, or maintenance equipment 1312.

The hardware in control system 1314 may be using hardware that may include computers, circuits, networks, and other types of equipment. The control may take the form of direct control of manufacturing equipment 1306. For example, robots, computer-controlled machines, and other equipment may be controlled by control system 1314. In other illustrative examples, control system 1314 may manage operations performed by human operators 1316 in manufacturing or performing maintenance on an aircraft. For example, control system 1314 may assign tasks, provide instructions, display models, or perform other operations to manage operations performed by human operators 1316. In these illustrative examples, controller 110 in FIG. 1 may be implemented in control system 1314 to manage at least one of the manufacturing or maintenance of an aircraft. In particular, controller 110 may be used to manage the wireless transfer of power to wireless motors that may be used in product management system 1300.

In the different illustrative examples, human operators 1316 may operate or interact with at least one of manufacturing equipment 1306, maintenance equipment 1312, or control system 1314. This interaction may be performed to manufacture an aircraft.

Of course, product management system 1300 may be configured to manage other products other than an aircraft. Although product management system 1300 has been described with respect to manufacturing in the aerospace industry, product management system 1300 may be configured to manage products for other industries. For example, product management system 1300 may be configured to manufacture products for the automotive industry as well as any other suitable industries.

Thus, with one or more illustrative embodiments, different operations such as manufacturing and maintenance of products may be performed more efficiently. For example, the number of wires may be reduced through the use of wireless motors. As a result, maintenance needed to refurbish, replace, or untwist cables carrying power may be reduced.

Additionally, wireless motor system 100 in FIG. 1 may be used to supply power to wireless motors more efficiently. With the use of wireless motor system 100, the amount of power that is wirelessly transmitted may be closer to what is needed by the wireless motors as compared to currently used systems. As a result, greater efficiency in the use of power may occur. In this manner, the cost for manufacturing and maintenance of products may be reduced.

With wireless motor system 100, multiple platforms, such as robots, may be powered with less time, effort, and maintenance, as compared to currently used electric motor power systems. For example, issues with wires were avoided with wireless motor system 100. Further, managing the supply of power to wireless motors may be performed in a manner that reduces the amount of monitoring and adjustments needed by human operators.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A robot power system comprising:
a controller that receives a request for power for a group of wireless motors associated with a robot; identifies an amount of power available from a power source for wireless transmission to the group of wireless motors; and controls operation of the robot based on the amount of power available.

2. The robot power system of claim 1 further comprising:
a transmitter system that sends the power in wireless signals to the group of wireless motors during the operation of the transmitter system.

3. The robot power system of claim 1 further comprising:
the power source and the robot.

4. The robot power system of claim 1, wherein in controlling the operation of the robot, the controller controls the operation of a transmitter system to send the power in wireless signals to the group of wireless motors based on the amount of power available from the power source.

5. The robot power system of claim 1, wherein the controller receives feedback from the robot indicating the power being sent to the group of wireless motors is insufficient and increases the power sent to the group of wireless motors when the amount of power available from the power source is sufficient to increase the power being sent to the group of wireless motors.

6. The robot power system of claim 1, wherein in controlling the operation of the robot, the controller sends a power schedule to the robot.

7. The robot power system of claim 1, wherein in controlling the operation of the robot, the controller changes a task performed by the robot.

8. The robot power system of claim 1, wherein the request for the power is selected from at least one of an identification of a task to be performed by the group of wireless motors or a desired amount of power for a selected period of time.

9. The robot power system of claim 1, wherein a task is selected from one of drilling a hole, applying sealant, applying paint, installing fasteners, performing an inspection, moving the robot, and moving an arm for the robot.

10. The robot power system of claim 1, wherein the controller is located at a location selected from at least one of a power source, the robot, or a remote location.

11. An apparatus comprising:
a transmitter system that sends power in wireless signals to a group of wireless motors during operation of the transmitter system; and
a controller that receives a request for the power for the group of wireless motors; identifies an amount of power available from a power source for wireless transmission to the group of wireless motors; and controls the operation of the transmitter system to send the power in the wireless signals to the group of wireless motors based on the amount of power available from the power source.

12. The apparatus of claim 11, wherein the controller controls the operation of the group of wireless motors based on the sending of the power to the wireless signals and performing at least one of sending a power schedule or modifying a task performed by the group of wireless motors.

13. The apparatus of claim 11, wherein the controller receives feedback indicating the power being sent to the group of wireless motors is insufficient and increases the power sent to the group of wireless motors when the amount of power available from the power source is sufficient to increase the power being sent.

14. A method for supplying power to a group of wireless motors, the method comprising:
receiving a request for the power for the group of wireless motors associated with a robot;
identifying an amount of power available from a power source for wireless transmission to the group of wireless motors; and
controlling operation of the group of wireless motors based on the amount of power available.

15. The method of claim 14, wherein controlling the operation of the group of wireless motors based on the amount of power available comprises:
sending the power in wireless signals to the group of wireless motors based on the amount of power available from the power source.

16. The method of claim 14 further comprising:
receiving feedback from the robot indicating the power being sent to the group of wireless motors is insufficient; and
increasing the power sent to the group of wireless motors when the amount of power available from the power source is sufficient to increase the power being sent to the group of wireless motors.

17. The method of claim 14, wherein the controlling step comprises:
sending a power schedule to the robot.

18. The method of claim 14, wherein the request for the power is selected from at least one of an identification of a task to be performed by the group of wireless motors or a desired amount of power for a selected period of time.

19. The method of claim 18, wherein the task is selected from one of drilling a hole, applying sealant, moving an item, installing fasteners, performing an inspection, moving the robot, and moving an arm for the robot.

20. The method of claim 14, wherein the receiving, identifying, and controlling steps are performed by a controller located at a location selected from at least one of a power source, the robot, or a remote location.
